(19) United States
(12) Patent Application Publication
(10) Pub. No.: US 2025/0208883 A1
(43) Pub. Date: Jun. 26, 2025

(54) TASK ASSOCIATION METHOD AND APPARATUS, AND ELECTRONIC DEVICE

(71) Applicant: Beijing Zitiao Network Technology Co., Ltd., Haidian District, Beijing (CN)

(72) Inventors: Yue ZHAO, Beijing (CN); Xinxin ZHANG, Beijing (CN); Hongxiang CAI, Beijing (CN); Zhihui CHEN, Beijing (CN); Zhi ZHOU, Beijing (CN)

(21) Appl. No.: 18/849,110

(22) PCT Filed: Mar. 17, 2023
(86) PCT No.: PCT/CN2023/082150

§ 371 Date: Sep. 20, 2024

(30) Foreign Application Priority Data
Mar. 22, 2022 (CN) 202210304744.7

(51) Int. Cl. G06F 9/451

(52) U.S. Cl. CPC G06F 9/451

(57) ABSTRACT

The present disclosure relates to the technical field of software, and in particular to a task association method and apparatus, and an electronic device. The method includes: displaying a first user interface, the first user interface including problem description information and a first control corresponding to the problem description information, and the first user interface is an interface of a first software platform; in response to an input for the first control, determining, in a second software platform, a first task corresponding to the problem description information, the first task being used for solving a problem corresponding to the problem description information; and associating the problem description information with the first task.

### CROSS-REFERENCE TO RELATED APPLICATIONS

This application claims priority to Chinese Application No. 202210304744.7, filed on Mar. 22, 2022, and entitled “Task Association Method and Apparatus, and Electronic Device”, the disclosure of which is incorporated herein by reference in its entity.

### FIELD

The present disclosure relates to the technical field of software, and in particular to a task association method and apparatus, and an electronic device.

### BACKGROUND

During the process of developing a product, after the product is developed, the product will be tried, some problems fed back by users will be collected and arranged in a use process, and then some tasks are recreated based on these problems to optimize these problems, so as to optimize the product. At present, the collection and arrangement of problems usually may be implemented by some electronic tables, and tasks to be created to optimize these problems need to be created by some software management platforms. Therefore, the present flows from the collection and arrangement of the problems to the creation of the tasks are tedious, and the efficiency is low.

### SUMMARY

In order to solve the above technical problems or at least partially solve the above technical problems, the present disclosure provides a task association method, which may simplify a product optimization flow and improve the efficiency.

To achieve the above objective, the technical solutions provided in the embodiments of the present disclosure are as follows:

In a first aspect, a task association method is provided, including: displaying a first user interface, wherein the first user interface includes problem description information and a first control corresponding to the problem description information, and the first user interface is an interface of a first software platform; in response to an input for the first control, determining, in a second software platform, a first task corresponding to the problem description information, wherein the first task is used for solving a problem corresponding to the problem description information; and associating the problem description information with the first task.

As an optional implementation of the embodiments of the present disclosure, the first control is a creation control, and in response to the input for the first control, determining, in the second software platform, the first task corresponding to the problem description information, includes: in response to an input for the creation control, creating, in the second software platform, the first task corresponding to the problem description information.

As an optional implementation of the embodiments of the present disclosure, in response to the input for the creation control, creating, in the second software platform, the first task corresponding to the problem description information, includes: in response to the input for the creation control, creating the first task, and displaying an information interface of the first task in the second software platform, acquiring description information of the first task according to the problem description information, and displaying the description information of the first task in the information interface of the first task.

As an optional implementation of the embodiments of the present disclosure, the description information of the first task includes at least one of the following: a name of the first task, remark information of the first task, a service line of the first task, or a contact person of the first task.

Generating the description information of the first task according to the problem description information includes: extracting key description information from the problem description information, and determining the name of the first task according to the key description information; and/or, determining target information according to the problem description information, wherein the target information includes at least one of the following information: the key description information, problem details of the problem corresponding to the problem description information, or presenter information of the problem; and determining the remark information of the first task according to the target information; and/or, determining a product involved in the problem corresponding to the problem description information; and determining a service line of the product as the service line of the first task; and/or, determining a product involved in the problem corresponding to the problem description information; and determining a contact person of the product as the contact person of the first task.

As an optional implementation of the embodiments of the present disclosure, the first control is an association control, and in response to the input for the first control, determining, in the second software platform, the first task corresponding to the problem description information, includes: in response to an input for the association control, determining, from created tasks of the second software platform, the first task corresponding to the problem description information.

As an optional implementation of the embodiments of the present disclosure, in response to the input for the association control, determining, in the created tasks of the second software platform, the first task corresponding to the problem description information, includes: in response to the input for the association control, displaying an associated task search interface, wherein the associated task search interface includes a search entry; and in response to a search input for the search entry, acquiring search information corresponding to the search input, determining, in the created tasks of the second software platform, the first task matching the search information, and determining the first task as a task corresponding to the problem description information, wherein the search information is a task identifier, or the search information is a keyword in the problem description information.

As an optional implementation of the embodiments of the present disclosure, associating the problem description information with the first task includes: acquiring, in the second software platform, a task identifier of the first task and state information of the first task; and correspondingly storing the task identifier, the state information and the problem description information in a database.

The first user interface further includes problem state information corresponding to the problem description information.

Correspondingly storing the task identifier, the state information and the problem description information in the database includes: updating the problem state information in the first user interface according to the state information of the first task.

As an optional implementation of the embodiments of the present disclosure, acquiring, in the second software platform, the task identifier of the first task and the state information of the first task, includes: sending, by the second software platform, the task identifier of the first task and the state information of the first task to the first software platform in a webpage callback manner, so that the first software platform acquires the task identifier of the first task and the state information of the first task.

As an optional implementation of the embodiments of the present disclosure, the first user interface further includes problem state information corresponding to the problem description information, and the problem state information indicates an uncompleted state.

The method further includes: in a case where the problem state information is updated from indicating the uncompleted state to indicating a completed state in response to an input of a user for the problem state information in the first user interface, maintaining the state information of the first task unchanged in the second software platform, and/or sending a notification message to the second software platform, wherein the notification message is used for prompting that the problem corresponding to the problem description information has been solved in a manner other than the first task, and the state information of the first task is used for indicating whether the first task has been completed; and in a case where the state information of the first task in the second software platform is updated from indicating the uncompleted state to indicating the completed state, updating the problem state information in the first user interface from indicating the uncompleted state to indicating the completed state.

As an optional implementation of the embodiments of the present disclosure, the first user interface further includes problem state information corresponding to the problem description information, the problem state information indicates a to-be-processed state, and the method further includes: after associating the problem description information with the first task, updating the problem state information from the to-be-processed state to a being-optimized state.

In a second aspect, provided is a task association apparatus, including: a display module, configured to display a first user interface, wherein the first user interface includes problem description information and a first control corresponding to the problem description information, and the first user interface is an interface of a first software platform; a determination module, configured to: in response to an input for the first control, determine, in a second software platform, a first task corresponding to the problem description information, wherein the first task is used for solving a problem corresponding to the problem description information; and an association module, configured to associate the problem description information with the first task.

As an optional implementation of the embodiments of the present disclosure, the first control is a creation control, and the determination module is specifically configured to: in response to an input for the creation control, create, in the second software platform, the first task corresponding to the problem description information.

As an optional implementation of the embodiments of the present disclosure, the determination module is specifically configured to: in response to the input for the creation control, create the first task, and display an information interface of the first task in the second software platform, acquire description information of the first task according to the problem description information, and display the description information of the first task in the information interface of the first task.

As an optional implementation of the embodiments of the present disclosure, the description information of the first task includes at least one of the following: a name of the first task, remark information of the first task, a service line of the first task, or a contact person of the first task.

The determination module is specifically configured to: extract key description information from the problem description information, and determine the name of the first task according to the key description information; and/or, determine target information according to the problem description information, wherein the target information includes at least one of the following information: the key description information, problem details of the problem corresponding to the problem description information, or presenter information of the problem; and determine the remark information of the first task according to the target information; and/or, determine a product involved in the problem corresponding to the problem description information; and determine a service line of the product as the service line of the first task; and/or, determine a product involved in the problem corresponding to the problem description information; and determine a contact person of the product as the contact person of the first task.

As an optional implementation of the embodiments of the present disclosure, the first control is an association control, and the determination module is specifically configured to: in response to an input for the association control, determine, from created tasks of the second software platform, the first task corresponding to the problem description information.

As an optional implementation of the embodiments of the present disclosure, the determination module is specifically configured to: in response to the input for the association control, display an associated task search interface, wherein the associated task search interface includes a search entry; and in response to a search input for the search entry, acquire search information corresponding to the search input, determine, from the created tasks of the second software platform, the first task matching the search information, and determine the first task as a task corresponding to the problem description information, wherein the search information is a task identifier, or the search information is a keyword in the problem description information.

As an optional implementation of the embodiments of the present disclosure, the association module is specifically configured to: acquire, in the second software platform, a task identifier of the first task and state information of the first task; and correspondingly store the task identifier, the state information and the problem description information in a database; wherein the first user interface further includes problem state information corresponding to the problem description information; and update the problem state information in the first user interface according to the state information of the first task.

As an optional implementation of the embodiments of the present disclosure, the association module is specifically configured to: send, by the second software platform, the task identifier of the first task and the state information of the first task to the first software platform in a webpage callback manner, so that the first software platform acquires the task identifier of the first task and the state information of the first task.

As an optional implementation of the embodiments of the present disclosure, the first user interface further includes problem state information corresponding to the problem description information, and the problem state information indicates an uncompleted state.

the display module is further configured to: in a case where the problem state information is updated from indicating the uncompleted state to indicating a completed state in response to an input of a user for the problem state information in the first user interface, maintain the state information of the first task unchanged in the second software platform, and/or send a notification message to the second software platform, wherein the notification message is used for prompting that the problem corresponding to the problem description information has been solved in a manner other than the first task, and the state information of the first task is used for indicating whether the first task has been completed; and in a case where the state information of the first task in the second software platform is updated from indicating the uncompleted state to indicating the completed state, update the problem state information in the first user interface from indicating the uncompleted state to indicating the completed state.

As an optional implementation of the embodiments of the present disclosure, the first user interface further includes problem state information corresponding to the problem description information, the problem state information indicates a to-be-processed state, and the display module is further configured to: update the problem state information from the to-be-processed state to a being-optimized state.

In a third aspect, provided is an electronic device, including a processor, a memory, and a computer program stored on the memory and capable of running on the processor, wherein the computer program implements, when executed by the processor, the task association method according to the first aspect or any optional implementation of the first aspect.

In a fourth aspect, provided is a computer-readable storage medium, storing a computer program thereon, wherein the computer program implements, when executed by a processor, the task association method according to first aspect or any optional implementation of the first aspect.

In a fifth aspect, provided is a computer program product, including a computer program, wherein when the computer program product is running on a computer, the computer is caused to implement the task association method according to first aspect or any optional implementation of the first aspect.

Compared with the prior art, the technical solutions provided in the embodiments of the present disclosure have the following advantages: the first user interface (including the problem description information) in the first software platform may be docked with the second software platform. In this way, in the first user interface, for the input of the first control, it may be triggered to determine, in the second software platform, the first task corresponding to the problem description information, and the first task is associated with the problem description information. Therefore, the operation is very convenient, the product optimization flow can be simplified, and the manual dependence is reduced.

### BRIEF DESCRIPTION OF THE DRAWINGS

The drawings herein are incorporated in and constitute a part of the present specification, illustrate embodiments conforming to the present disclosure, and are used for explaining the principles of the present disclosure together with the specification.

To illustrate technical solutions in the embodiments of the present disclosure or in the prior art more clearly, a brief introduction on the drawings which are needed in the description of the embodiments or the prior art is given below. Apparently, other drawings may also be obtained by those ordinary skilled in the art according to these drawings without any creative effort.

FIG. 1 is a schematic flowchart of a task association method provided in an embodiment of the present disclosure;

FIG. 2 is a first schematic diagram of an interface provided in an embodiment of the present disclosure;

FIG. 3 is a second schematic diagram of an interface provided in an embodiment of the present disclosure;

FIG. 4 is a third schematic diagram of an interface provided in an embodiment of the present disclosure;

FIG. 5 is a fourth schematic diagram of an interface provided in an embodiment of the present disclosure;

FIG. 6 is a fifth schematic diagram of an interface provided in an embodiment of the present disclosure;

FIG. 7 is a structural block diagram of a task association apparatus provided in an embodiment of the present disclosure; and

FIG. 8 is a schematic diagram of a hardware structure of an electronic device provided in an embodiment of the present disclosure.

### DETAILED DESCRIPTION OF EMBODIMENTS

In order to understand the above objectives, features and advantages of the present disclosure more clearly, the solutions of the present disclosure will be further described below. It should be noted that, in the case of no conflict, embodiments of the present disclosure and features in the embodiments may be combined with each other.

In the following description, numerous specific details are set forth to fully understand the present disclosure, but the present disclosure may also be implemented in other manners other than those described herein; and obviously, the embodiments in the specification are only a part, but not all, of the embodiments of the present disclosure.

In a current product optimization flow, regarding problem collection and arrangement, task creation and state update after task creation, whole flow needs to be manually controlled, so the current product optimization flow is tedious and high in manual dependence.

In order to solve the above problems, an embodiment of the present disclosure provides a task association method, which may dock a first user interface (including problem description information) in a first software platform with a second software platform. In this way, in the first user interface, for an input of a first control, it may be triggered to determine, in a second software platform, a first task corresponding to the problem description information, and the first task is associated with the problem description information. Therefore, the operation is very convenient, the product optimization flow can be simplified, and the manual dependence is reduced.

The task association method provided in the embodiment of the present disclosure may be implemented by a task association apparatus or an electronic device, and the task association apparatus may be a functional module or a functional entity, which is used for implementing the task association method, in the electronic device.

The electronic device may be a mobile phone, a tablet computer, a notebook computer, a palm computer, an in-vehicle terminal, a wearable device, an ultra-mobile personal computer (UMPC), a netbook or a personal digital assistant (PDA), a personal computer (PC), or the like, which is not specifically limited in the embodiment of the present disclosure.

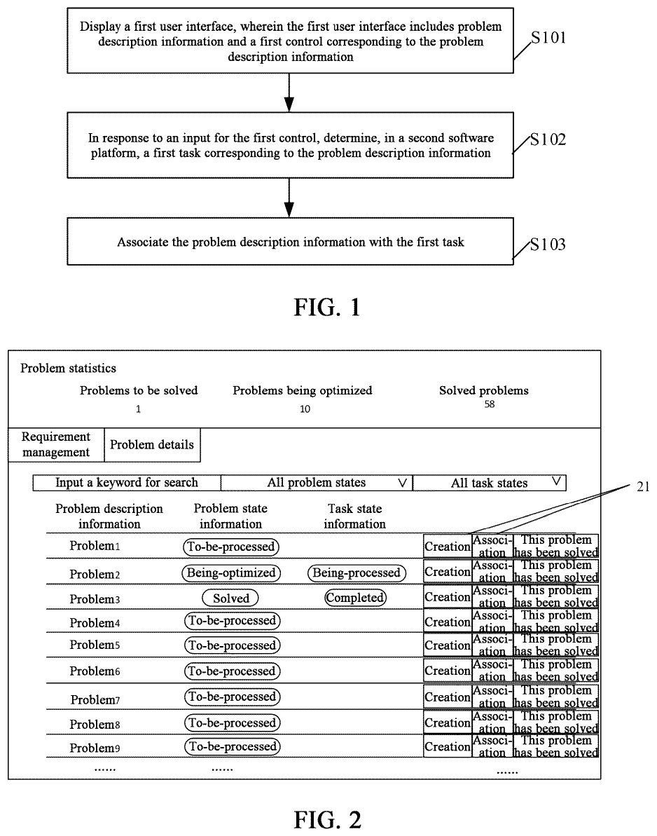

As shown in FIG. 1, it is a schematic flowchart of a task association method provided in an embodiment of the present disclosure, and the method includes the following:
S101: a first user interface is displayed, the first user interface includes problem description information and a first control corresponding to the problem description information.

The first user interface is an interface of a first software platform. The first software platform may be a data statistics and analysis platform. In the first software platform, problem description information of some problems fed back by the user after using a certain product may be collected, and the problem description information is displayed in the first user interface.

The first user interface is used for feeding back user experience of using the product, and thus may be referred to as a user experience feedback interface.

Exemplarily, as shown in FIG. 2, FIG. 2 is a first schematic diagram of an interface provided in an embodiment of the present disclosure. The interface shown in FIG. 2 is the first user interface, statistics is performed on optimization problems of a product in the interface, and the problem description information of a plurality of problems is displayed. Each problem description information is correspondingly provided with a first control 21, and both a “creation” control and an “association” control in FIG. 2 may be understood as the first control.
S102: in response to an input for the first control, a first task corresponding to the problem description information is determined in a second software platform.

The first task is used for solving a problem corresponding to the problem description information. The first task may be a newly added task in the second software platform, the first task may also be a created task in the second software platform, and description will be respectively given below for the two cases.

The manner of determining, in the second software platform, the first task corresponding to the problem description information may include: determining, via an open application program interface (OpenAPI) of the second software platform, an identifier of the first task corresponding to the problem description information, and correspondingly storing the identifier of the first task and the problem description information.
Case 1: the first task is a newly added task in the second software platform.

In some embodiments, the first control is a creation control, and in response to an input for the creation control, the first task corresponding to the problem description information is created in the second software platform.

Exemplarily, as shown in FIG. 2, after the “creation” control set for a problem 1 is operated, a new first task corresponding to the problem 1 may be created in the second software platform based on the problem 1.

In some embodiments, in response to the input for the creation control, the first task may be created, an information interface of the first task in the second software platform is displayed, description information of the first task is acquired according to the problem description information, and the description information of the first task is displayed in the information interface of the first task.

The description information of the first task may include one or more of the following: a name of the first task, remark information of the first task, a service line of the first task, or a contact person of the first task.

The acquiring the description information of the first task according to the problem description information may include at least one of the following implementations:

In one implementation, key description information is extracted from the problem description information, and the name of the first task is determined according to the key description information.

The key description information may be fields or sentences, and the name of the first task may be determined based on these fields or sentences. In the embodiment of the present disclosure, part or all of the problem description information may be determined as the name.

In one implementation, target information is determined according to the problem description information, and then the remark information of the first task is determined according to the target information.

Exemplarily, the target information includes at least one of the following information: the key description information, problem details of the problem corresponding to the problem description information, or presenter information of the problem.

Exemplarily, the remark information of the first task may be determined according to one or more of the key description information, the problem details of the problem corresponding to the problem description information, or the presenter information of the problem.

The key description information may be a keyword or a sentence extracted from the problem description information. The problem details of the problem corresponding to the problem description information and the presenter information of the problem may be information stored in association with the problem description information.

In one implementation, a product involved in the problem corresponding to the problem description information is determined; and a service line of the product is determined as the service line of the first task, the service line may also be understood as a department or other organization units.

The service line may be a service line to which the problem corresponding to the problem description information belongs. The service line may be a service category to which a pre-divided problem belongs, and generally, different service lines may be divided for different products.

In one implementation, a product involved in the problem corresponding to the problem description information is determined; and a contact person of the product is determined as the contact person of the first task.

Generally, a corresponding contact person will be set for the product, and then the contact person of the product may be determined as the contact person of the first task corresponding to the related problem.

Some description information of the first task, which is acquired according to the problem description information, may be automatically filled in the information interface of the first task, and other information, which cannot be acquired, may be filled in the information interface of the first task in a manual filling manner. In the embodiment of the present disclosure, a plurality of methods for acquiring the description information of the first task are provided, and the description information of the first task may be flexibly obtained in these manners according to actual requirements.

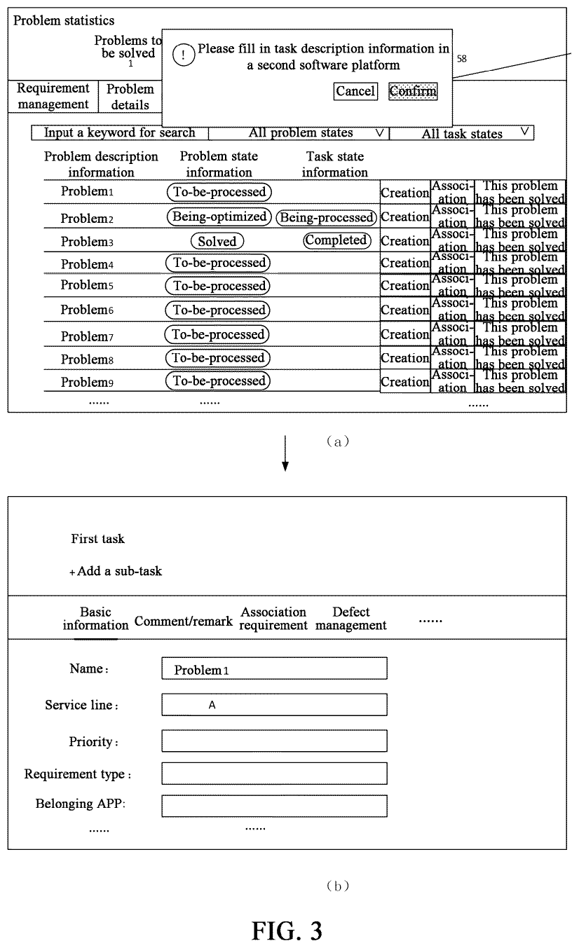

As shown in FIG. 3, it is a second schematic diagram of an interface provided in an embodiment of the present disclosure. In (a) in FIG. 3, in response to the input for the “creation” control of the problem 1, a prompt window 31 shown in (a) in FIG. 3 may be displayed to prompt that a new task is created in the second software platform. The description information corresponding to the task needs to be filled. After the user clicks a “confirm” control in the prompt window 31, a task information filling interface of the second software platform shown in (b) in FIG. 3 is displayed, and the problem description information and other information (e.g., a product associated with the problem description information, the presenter information of the problem associated with the problem description information, the service line of the product, and the like) associated with the problem description information may be acquired in the first software platform and are automatically filled in the task information filling interface of the second software platform. It can be seen from (b) in FIG. 3 that, for basic information of the first task, two information, that is, “name” and “service line”, may be filled in advance based on the information acquired from the first software platform. In (b) in FIG. 3, the problem 1 is directly used as the name of the task, and a service line A of the problem 1 is used as the service line of the first task.

In the embodiment of the present disclosure, the interface of the second software platform may be triggered and displayed by an operation in the first software platform, and the first task corresponding to the problem description information in the first software platform is established by an operation in the second software platform, thereby simplifying a task creation flow in the product optimization flow.
Case 2: the first task is a created task in the second software platform.

In some embodiments, the first control is an association control, and in response to an input for the association control, the first task corresponding to the problem description information is determined in created tasks of the second software platform.

Exemplarily, as shown in FIG. 2, after the “association” control set for the problem 1 is operated, at least one created task corresponding to the problem 1 may be searched for, as the first task, in the created tasks of the second software platform based on the problem 1.

In some embodiments, in response to the input for the association control, an associated task search interface may be displayed, and the associated task search interface includes a search entry. In response to a search input for the search entry, a first task matching the search information is determined in the created tasks of the second software platform according to the search information corresponding to the search input, and the first task is used as a task corresponding to the problem description information. Further, the search information may also be displayed in the search entry.

The search information includes a task identifier (i.e., the identifier of the first task), or the search information includes a keyword in the problem description information.

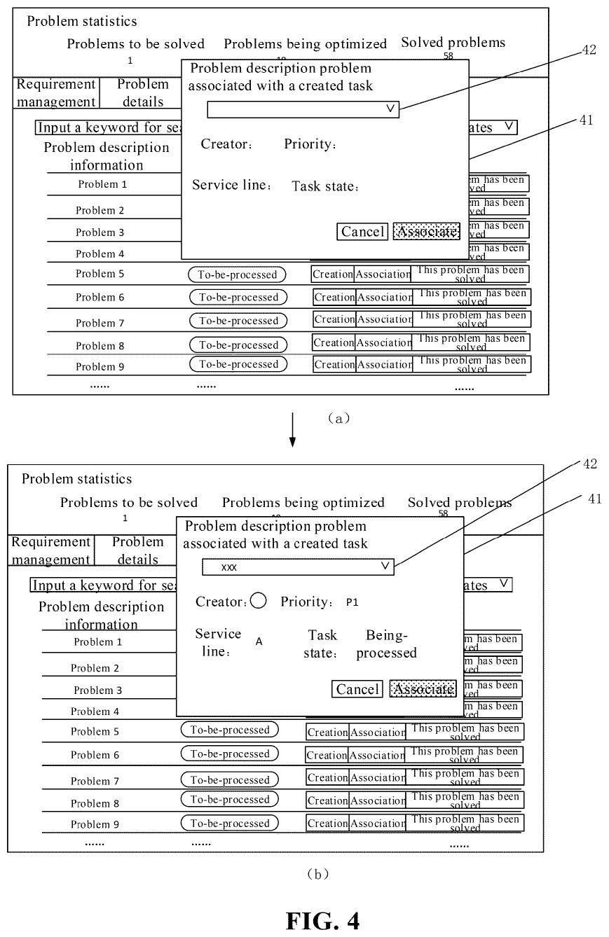

Exemplarily, as shown in FIG. 4, FIG. 4 is a third schematic diagram of an interface provided in an embodiment of the present disclosure. In response to an operation on the “association” control corresponding to the problem 1, an associated task search interface 41 shown in (a) in FIG. 4 may be displayed. The associated task search interface 41 includes a search entry 42. After search information “XXX” is input into the search entry, “XXX” may be displayed in the search entry 42, and information of the created task corresponding to the “XXX” is matched, updated and displayed in the associated task search interface 41. As shown in (b) in FIG. 4, information such as a creator, a priority, a service line, a task state and the like of the created task may be displayed, and the task state shown in FIG. 4 may be referred to as task state information.

In the embodiment of the present disclosure, the search interface for the task information of the second software platform may be triggered and displayed by an operation in the first software platform, for example, the task search interface in the second software platform, and the first task corresponding to the problem description information in the first software platform is searched by the search in the second software platform, thereby simplifying a task association flow in the product optimization flow.
S103: the problem description information is associated with the first task.

In some embodiments, a task identifier of the first task and state information of the first task may be acquired in the second software platform at first; and then the task identifier, the state information and the problem description information are correspondingly stored in a database, and the database is a database corresponding to the first user interface. It should be noted that, both the task state information and the problem state information displayed in the first user interface may be changed synchronously with data update in the database.

The manner of acquiring the task identifier of the first task and the state information of the first task in the second software platform may include that: the second software platform sends the task identifier of the first task and the state information of the first task to the first software platform in a webpage callback manner, so that the first software platform acquires the task identifier of the first task and the state information of the first task.

In the embodiment of the present disclosure, the first user interface further includes problem state information corresponding to the problem description information, and the method further includes: after correspondingly storing the task identifier, the state information and the problem description information in the database, updating the problem state information in the first user interface according to the state information of the first task.

In the above embodiment, the task identifier and the state information of the first task may be correspondingly stored with the problem description information, and the problem state information in the corresponding first user interface may be updated according to the state information of the first task, so that an association relationship between the state information of the first task and the problem description information is established. In this way, the problem state information in the first user interface may be changed in real time according to the state information of the first task.

In the embodiment of the present disclosure, the problem state information corresponding to the problem description information is used for representing a handling condition of the problem corresponding to the problem description information. For example, the problem state information may include three states, that is, a to-be-processed state, a being-optimized state and a solved state. It can be understood that, the problem state information may be also divided into more or fewer states, and may be adjusted according to actual requirements, which is not limited in the embodiment of the present disclosure.

In the embodiment of the present disclosure, the first user interface may further include task state information corresponding to the problem description information, and the task state information may be updated according to the acquired state information of the first task.

In the embodiment of the present disclosure, the task state information is used for representing an execution condition of the task. For example, the task state information may include two states, that is, a being-processed state and a completed state. It can be understood that the task state information may also be divided into more or fewer states, and may be adjusted according to actual requirements, which is not limited in the embodiment of the present disclosure.

In the embodiment of the present disclosure, when the problem description information is associated with the first task, the problem state information corresponding to the problem description information may be correspondingly updated. For example, when the problem state information indicates a to-be-processed state, after the problem description information is associated with the first task, the problem state information is updated from the to-be-processed state to the being-optimized state.

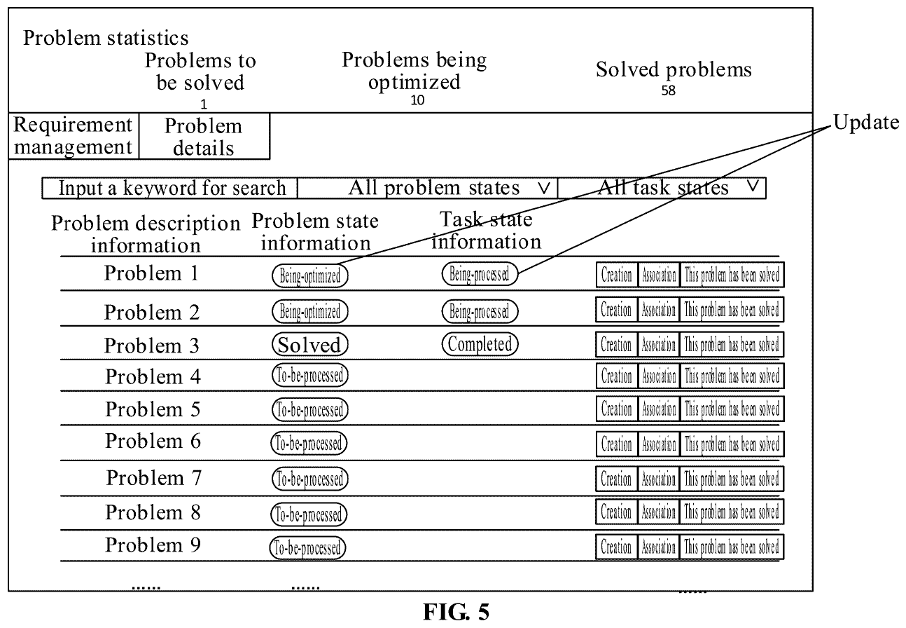

Exemplarily, as shown in FIG. 5, FIG. 5 is a fourth schematic diagram of an interface provided in an embodiment of the present disclosure, the interface shown in FIG. 5 is the first user interface, and the interface shown in FIG. 5 may be obtained after the first user interface shown in FIG. 2 is updated. Specifically, in the first user interface shown in FIG. 2, the problem 1 is not associated with a related task, but after the problem 1 is associated with a new task by triggering the “creation” control, or after the problem 1 is associated with a created task by triggering the “association” control, the problem state information of the problem 1 is no longer “to-be-processed”, but may be changed to “being-optimized”, and the state information of the task associated with the problem 1 may also be updated to “being-processed”. Further, after the related task of the problem 1 is completed, the problem state information may be further updated to “solved”, and the task state information is updated to “completed”.

In the task association method provided in the embodiment of the present disclosure, the first user interface (including the problem description information) in the first software platform may be docked with the second software platform. In this way, in the first user interface, for the input of the first control, it may be triggered to determine, in the second software platform, the first task corresponding to the problem description information, and the first task is associated with the problem description information. Therefore, the operation is very convenient, the product optimization flow can be simplified, and the manual dependence is reduced.

In some embodiments, in a case where some problems may have no associated task, if these problems have been resolved, then the problem state information may be manually modified.

In some embodiments, in a case where although some problems are associated with a task, these problems have been solved in other manners before the task is executed, and then the problem state information may be modified in the first user interface in other manners such as a manual manner.

In some embodiments, the first user interface further includes problem state information corresponding to the problem description information, and the problem state information indicates an uncompleted state. In a case where the problem state information is updated from indicating the uncompleted state to indicating a completed state in response to an input of a user for the problem state information in the first user interface, the state information of the first task is maintained unchanged in the second software platform, and/or a notification message is sent to the second software platform, the notification message is used for prompting that the problem corresponding to the problem description information has been solved in a manner other than the first task, and the state information of the first task is used for indicating whether the first task has been completed.

The uncompleted state may include a to-be-processed state and a being-optimized state.

In the above embodiment, in a case where the problem state information is updated from indicating the uncompleted state to indicating the completed state in response to the input of the user for the problem state information in the first user interface, the state information of the first task is maintained unchanged in the second software platform. In general, there is a case where one task corresponds to a plurality of pieces of problem description information, that is, a plurality of problems may be solved by the same task. When the problem state information is changed without being triggered by the completion progress of the first task, the first task may also be associated with other problems other than the problem indicated by the problem state information, therefore by maintaining the state information of the first task unchanged, it is possible to avoid influencing solving other problems associated with the first task.

In a case where the state information of the first task remains unchanged, information associated with the first task may be changed, for example, an association relationship between the first task and the problem state information may be deleted.

In a case where the state information of the first task remains unchanged, the second software platform may receive the notification message sent by the first software platform, the notification message is used for indicating that the problem corresponding to the problem description information has been solved in a manner other than the first task. Further, the second software platform may set annotation content for the first task according to the notification message, the annotation content is used for indicating that the problem indicated by the problem state information associated with the first task has been solved in a manner other than the first task, and the annotation content may also be displayed in the interface of the second software platform to prompt maintenance personnel of the second software platform, so that the maintenance personnel can conveniently evaluate, according to the annotation content, whether to continue the first task.

In general, there is a case where one task corresponds to a plurality of pieces of problem description information, that is, a plurality of problems may be solved by the same task, however, some problems may also be solved in other manners. When some problems are not solved by associated tasks thereof, the user may trigger to change the problem state information corresponding to the problem description information of the problem via a manual operation, for example, change the uncompleted state to a completed state. In this way, the solution progress of the problem corresponding to the problem description information can be flexibly adjusted.

The uncompleted state may be identified as “to-be-processed”, “being optimized”, “being-processed” and the like, and the completed state may be identified as “solved” and “completed”.

In some embodiments, the first user interface further includes problem state information corresponding to the problem description information, and in a case where the state information of the first task is updated from indicating the uncompleted state to indicating the completed state, the problem state information is updated from indicating the uncompleted state to indicating the completed state.

After the state information of the task is updated, the problem corresponding to the task is correspondingly solved in general, therefore once the state information of the task is updated, the problem state information of the problem corresponding to the task is synchronously updated, so that the synchronous update of the state information of the task and the problem state information can be realized in time, and a real-time problem solution progress is accurately reflected.

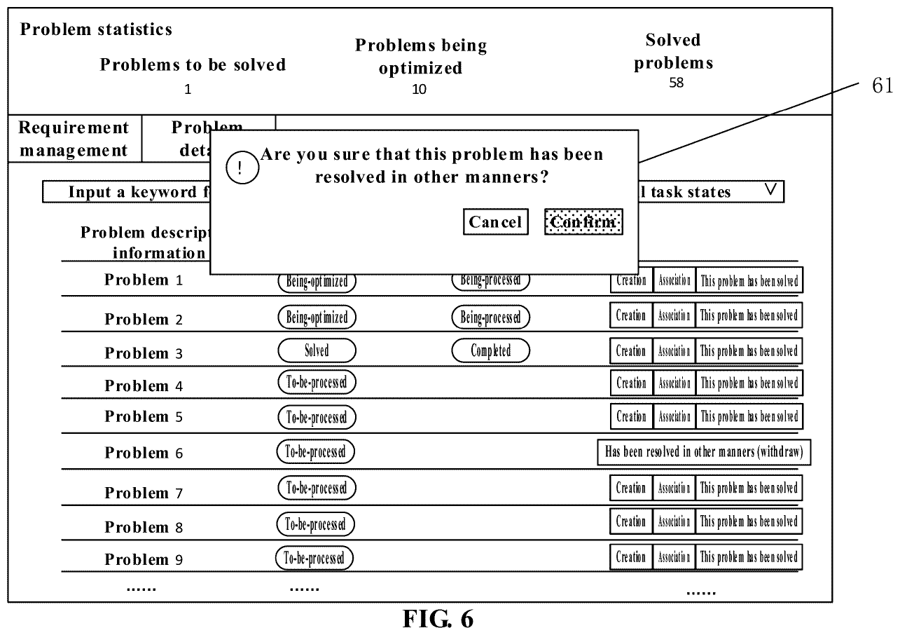

Exemplarily, as shown in FIG. 6, FIG. 6 is a fifth schematic diagram of an interface provided in an embodiment of the present disclosure. FIG. 6 is the first user interface. For a problem 6 in the interface, in a case where the problem has been solved and is not solved by a task created in the second software platform, the problem state information of the problem 6 may be updated to solved by clicking the control “this problem has been solved”. Further, after the control “this problem has been solved” is clicked, a prompt window 61 as shown in FIG. 6 may also be displayed to prompt the user to confirm whether the problem 6 has been solved in other manners, so as to avoid touching the control “this problem has been solved” by mistake to result in mistaken update of the problem state information.

In the above embodiment, for exceptional cases where some problems are solved in other manners, a corresponding control may also be set on the first user interface to facilitate manual modification of the problem state information. In this way, it is possible to avoid the case where the problem state information cannot be updated in time in these exceptional cases, and the performance of human-computer interaction is improved.

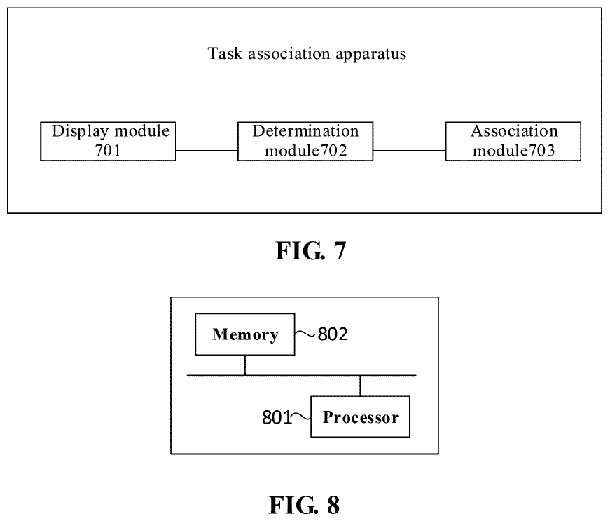

As shown in FIG. 7, an embodiment of the present disclosure provides a task association apparatus, including: a display module 701, a determination module 702 and an association module 703.

The display module 701 is configured to display a first user interface, wherein the first user interface includes problem description information and a first control corresponding to the problem description information, and the first user interface is an interface of a first software platform.

The determination module 702 is configured to: in response to an input for the first control, determine, in a second software platform, a first task corresponding to the problem description information, wherein the first task is used for solving a problem corresponding to the problem description information.

The association module 703 is configured to associate the problem description information with the first task.

As an optional implementation of the embodiments of the present disclosure, the first control is a creation control, and the determination module 702 is specifically configured to: in response to an input for the creation control, create, in the second software platform, the first task corresponding to the problem description information.

As an optional implementation of the embodiments of the present disclosure, the determination module 702 is specifically configured to: in response to the input for the creation control, create the first task, and display an information interface of the first task in the second software platform, acquire description information of the first task according to the problem description information, and display the description information of the first task in the information interface of the first task.

As an optional implementation of the embodiments of the present disclosure, the description information of the first task includes at least one of the following: a name of the first task, remark information of the first task, a service line of the first task, or a contact person of the first task.

The determination module 702 is specifically configured to: extract key description information from the problem description information, and determine the name of the first task according to the key description information; and/or, determine target information according to the problem description information, wherein the target information includes at least one of the following information: the key description information, problem details of the problem corresponding to the problem description information, or presenter information of the problem; and determine the remark information of the first task according to the target information; and/or, determine a product involved in the problem corresponding to the problem description information; and determine a service line of the product as the service line of the first task; and/or, determine a product involved in the problem corresponding to the problem description information; and determine a contact person of the product as the contact person of the first task.

As an optional implementation of the embodiments of the present disclosure, the first control is an association control, and the determination module 702 is specifically configured to: in response to an input for the association control, determine, from created tasks of the second software platform, the first task corresponding to the problem description information.

As an optional implementation of the embodiments of the present disclosure, the determination module 702 is specifically configured to: in response to the input for the association control, display an associated task search interface, wherein the associated task search interface includes a search entry; and in response to a search input for the search entry, acquire search information corresponding to the search input, determine, in the created tasks of the second software platform, the first task matching the search information, and determine the first task as a task corresponding to the problem description information, wherein the search information is a task identifier, or the search information is a keyword in the problem description information.

As an optional implementation of the embodiments of the present disclosure, the association module 703 is specifically configured to: acquire, in the second software platform, a task identifier of the first task and state information of the first task; and correspondingly store the task identifier, the state information and the problem description information in a database; wherein the first user interface further includes problem state information corresponding to the problem description information; and update the problem state information in the first user interface according to the state information of the first task.

As an optional implementation of the embodiments of the present disclosure, the association module 703 is specifically configured to: send, by the second software platform, the task identifier of the first task and the state information of the first task to the first software platform in a webpage callback manner, so that the first software platform acquires the task identifier of the first task and the state information of the first task.

As an optional implementation of the embodiments of the present disclosure, the first user interface further includes problem state information corresponding to the problem description information, and the problem state information indicates an uncompleted state.

The display module 701 is further configured to: in a case where the problem state information is updated from indicating the uncompleted state to indicating a completed state in response to an input of a user for the problem state information in the first user interface, maintain the state information of the first task unchanged in the second software platform, and/or send a notification message to the second software platform, wherein the notification message is used for prompting that the problem corresponding to the problem description information has been solved in a manner other than the first task, and the state information of the first task is used for indicating whether the first task has been completed; and in a case where the state information of the first task in the second software platform is updated from indicating the uncompleted state to indicating the completed state, update the problem state information in the first user interface from indicating the uncompleted state to indicating the completed state.

As an optional implementation of the embodiments of the present disclosure, the first user interface further includes problem state information corresponding to the problem description information, the problem state information indicates a to-be-processed state, and the display module 701 is further configured to: update the problem state information from the to-be-processed state to a being-optimized state.

As shown in FIG. 8, an embodiment of the present disclosure provides an electronic device, including a processor 801, a memory 802, and a computer program stored on the memory 802 and capable of running on the processor 801, the computer program implements, when executed by the processor 801, the processes of the task association method in the above method embodiments, and may achieve the same technical effects, thus details are not described herein again to avoid repetition.

An embodiment of the present invention provides a computer-readable storage medium, wherein a computer program is stored on the computer-readable storage medium, the computer program implements, when executed by a processor, the processes of the task association method in the above method embodiments, and may achieve the same technical effects, thus details are not described herein again to avoid repetition.

The computer-readable storage medium may be a read-only memory (ROM), a random access memory (RAM), a magnetic disk, an optical disk, or the like.

An embodiment of the present invention provides a computer program product, storing a computer program thereon, wherein the computer program implements, when executed by a processor, the processes of the task association method in the above method embodiments, and may achieve the same technical effects, thus details are not described herein again to avoid repetition.

Those skilled in the art should be aware that, the embodiments of the present disclosure may be provided as a method, a system or a computer program product. Accordingly, the present disclosure may adopt the form of a complete hardware embodiment, a complete software embodiment, or an embodiment combining software with hardware. Moreover, the present disclosure may adopt the form of a computer program product which is implemented on one or more computer-usable storage media containing computer-usable program codes.

In the present disclosure, the processor may be a central processing unit (CPU), and may also be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor may be a micro-processor, or the processor may also be any conventional processor, or the like.

In the present disclosure, the memory may include forms such as a volatile memory, a random access memory (RAM), and/or a non-volatile memory in a computer-readable medium, for example, a read-only memory (ROM) or a flash memory (flash RAM). The memory is an example of a computer-readable medium.

In the present disclosure, the computer-readable medium includes non-volatile and volatile, removable and non-removable storage media. The storage medium may implement information storage by using any method or technology, and the information may be a computer-readable instruction, a data structure, a program module or other data. Examples of the storage medium of a computer include, but are not limited to, a phase-change random access memory (PRAM), a static random access memory (SRAM), a dynamic random access memory (DRAM), other types of random access memories (RAMs), a read-only memory (ROM), an electrically erasable programmable read only memory (EEPROM), a flash memory or other memory technologies, a compact disc read-only memory (CD-ROM), a digital versatile disk (DVD) or other optical storages, a magnetic cassette, a magnetic disk storage or other magnetic storage devices or any other non-transmission medium, which may be used for storing information accessible by a computing device. According to the definition therein, the computer-readable medium does not include transitory media, such as a modulated data signal and a carrier.

It should be noted that herein, relational terms, such as “first”, “second” and the like, are merely used for distinguishing one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or also includes elements inherent to such a process, method, article or device. If there are no more restrictions, the element defined by the sentence “including a . . . ” does not exclude the existence of other identical elements in the process, the method, the article or the device that includes the element.

The above descriptions are merely specific implementations of the present disclosure, those skilled in the art can understand or implement the present disclosure. Various modifications to these embodiments will be readily apparent to those skilled in the art, and the generic principles defined herein may be implemented in other embodiments without departing from the spirit or scope of the present disclosure. Thus, the present disclosure will not be limited to these embodiments herein, but is to conform to the widest scope consistent with the principles and novel features disclosed herein.

What is claimed is:

1-13. (canceled)

14. A task association method, comprising:
displaying a first user interface, wherein the first user interface comprises problem description information and a first control corresponding to the problem description information, and the first user interface is an interface of a first software platform;
in response to an input for the first control, determining, in a second software platform, a first task corresponding to the problem description information, wherein the first task is used for solving a problem corresponding to the problem description information; and
associating the problem description information with the first task.

15. The method according to claim 14, wherein the first control is a creation control, and in response to the input for the first control, determining, in the second software platform, the first task corresponding to the problem description information, comprises:
in response to an input for the creation control, creating, in the second software platform, the first task corresponding to the problem description information.

16. The method according to claim 15, wherein in response to the input for the creation control, creating, in the second software platform, the first task corresponding to the problem description information, comprises:
in response to the input for the creation control, creating the first task, and displaying an information interface of the first task in the second software platform, acquiring description information of the first task according to the problem description information, and displaying the description information of the first task in the information interface of the first task.

17. The method according to claim 16, wherein the description information of the first task comprises at least one of the following:
a name of the first task, remark information of the first task, a service line of the first task, or a contact person of the first task.

18. The method according to claim 16, wherein acquiring the description information of the first task according to the problem description information comprises at least one of the following:
extracting key description information from the problem description information, and determining a name of the first task according to the key description information; or
determining target information according to the problem description information, wherein the target information includes at least one of the following information: the key description information, problem details of the problem corresponding to the problem description information, or presenter information of the problem; and determining remark information of the first task according to the target information; or
determining a product involved in the problem corresponding to the problem description information; and determining a service line of the product as a service line of the first task; or
determining a product involved in the problem corresponding to the problem description information; and determining a contact person of the product as a contact person of the first task.

19. The method according to claim 14, wherein the first control is an association control, and in response to the input for the first control, determining, in the second software platform, the first task corresponding to the problem description information, comprises:
in response to an input for the association control, determining, in created tasks of the second software platform, the first task corresponding to the problem description information.

20. The method according to claim 19, wherein in response to the input for the association control, determining, in the created tasks of the second software platform, the first task corresponding to the problem description information, comprises:
in response to the input for the association control, displaying an associated task search interface, wherein the associated task search interface comprises a search entry; and
in response to a search input for the search entry, acquiring search information corresponding to the search input, determining, in the created tasks of the second software platform, the first task matching the search information, and determining the first task as a task corresponding to the problem description information,
wherein the search information comprises a task identifier, or the search information comprises a keyword in the problem description information.

21. The method according to claim 14, wherein associating the problem description information with the first task comprises:
acquiring, in the second software platform, a task identifier of the first task and state information of the first task; and
correspondingly storing the task identifier, the state information and the problem description information in a database.

22. The method according to claim 21, wherein the first user interface further comprises problem state information corresponding to the problem description information; and
wherein correspondingly storing the task identifier, the state information and the problem description information in the database comprises:
updating the problem state information in the first user interface according to the state information of the first task.

23. The method according to claim 21, wherein acquiring, in the second software platform, the task identifier of the first task and the state information of the first task, comprises:
sending, by the second software platform, the task identifier of the first task and the state information of the first task to the first software platform in a webpage callback manner, so that the first software platform acquires the task identifier of the first task and the state information of the first task.

24. The method according to claim 14, wherein the first user interface further comprises problem state information corresponding to the problem description information; and
wherein the method further comprises at least one of:
in response to an input of a user for the problem state information in the first user interface, in a case where the problem state information is updated from indicating an uncompleted state to indicating a completed state, maintaining the state information of the first task unchanged in the second software platform, and/or, sending a notification message to the second software platform, wherein the notification message is used for prompting that the problem corresponding to the problem description information has been solved in a manner other than the first task, and the state information of the first task is used for indicating whether the first task has been completed; or
in a case where the state information of the first task in the second software platform is updated from indicating an uncompleted state to indicating a completed state, updating the problem state information in the first user interface from indicating an uncompleted state to indicating a completed state.

25. The method according to claim 14, wherein the first user interface further comprises problem state information corresponding to the problem description information, the problem state information indicates a to-be-processed state, and the method further comprises: after associating the problem description information with the first task, updating the problem state information from the to-be-processed state to a being-optimized state.

26. An electronic device, comprising: a processor, a memory, and a computer program stored on the memory and capable of running on the processor, wherein the computer program, when executed by the processor, causes the processor to:
display a first user interface, wherein the first user interface comprises problem description information and a first control corresponding to the problem description information, and the first user interface is an interface of a first software platform;
in response to an input for the first control, determine, in a second software platform, a first task corresponding to the problem description information, wherein the first task is used for solving a problem corresponding to the problem description information; and
associate the problem description information with the first task.

27. The electronic device according to claim 26, wherein the first control is a creation control, and the processor is caused to: in response to the input for the first control, determine, in the second software platform, the first task corresponding to the problem description information by being caused to:
in response to an input for the creation control, create, in the second software platform, the first task corresponding to the problem description information.

28. The electronic device according to claim 27, wherein the processor is configured to: in response to the input for the creation control, create, in the second software platform, the first task corresponding to the problem description information by being caused to:
in response to the input for the creation control, create the first task, and display an information interface of the first task in the second software platform, acquire description information of the first task according to the problem description information, and display the description information of the first task in the information interface of the first task.

29. The electronic device according to claim 28, wherein the description information of the first task comprises at least one of the following:
a name of the first task, remark information of the first task, a service line of the first task, or a contact person of the first task.

30. The electronic device according to claim 28, wherein acquiring the description information of the first task according to the problem description information comprises at least one of the following:
extracting key description information from the problem description information, and determining a name of the first task according to the key description information; or
determining target information according to the problem description information, wherein the target information includes at least one of the following information: the key description information, problem details of the problem corresponding to the problem description information, or presenter information of the problem; and determining remark information of the first task according to the target information; or
determining a product involved in the problem corresponding to the problem description information; and determining a service line of the product as a service line of the first task; or
determining a product involved in the problem corresponding to the problem description information; and determining a contact person of the product as a contact person of the first task.

31. The electronic device according to claim 26, wherein the first control is an association control, and the processor is caused to: in response to the input for the first control, determine, in the second software platform, the first task corresponding to the problem description information by being caused to:
in response to an input for the association control, determine, in created tasks of the second software platform, the first task corresponding to the problem description information.

32. The electronic device according to claim 31, wherein the processor is caused to:
in response to the input for the association control, determine, in the created tasks of the second software platform, the first task corresponding to the problem description information by being caused to:
in response to the input for the association control, display an associated task search interface, wherein the associated task search interface comprises a search entry; and
in response to a search input for the search entry, acquire search information corresponding to the search input, determine, in the created tasks of the second software platform, the first task matching the search information, and determine the first task as a task corresponding to the problem description information,
wherein the search information comprises a task identifier, or the search information comprises a keyword in the problem description information.

33. A non-volatile computer-readable storage medium, comprising: a computer program stored thereon, wherein the computer program implements, when executed by a processor:
displaying a first user interface, wherein the first user interface comprises problem description information and a first control corresponding to the problem description information, and the first user interface is an interface of a first software platform;
in response to an input for the first control, determining, in a second software platform, a first task corresponding to the problem description information, wherein the first task is used for solving a problem corresponding to the problem description information; and
associating the problem description information with the first task.
